(19) United States
(12) Patent Application Publication
(10) Pub. No.: US 2005/0250381 A1
(43) Pub. Date: Nov. 10, 2005

(54) Connector for a coaxial cable

(76) Inventor: Frank Hellin, Kortrijk (BE)

Correspondence Address: BARLEY SNYDER, LLC, 1000 WESTLAKES DRIVE, SUITE 275, BERWYN, PA, 19312, US

(21) Appl. No.: 11/049,766

(22) Filed: Feb. 3, 2005

(30) Foreign Application Priority Data
Feb. 5, 2004 (DE) 04250606.3

(51) Int. Cl. H01R 9/05

(52) U.S. Cl. 439/578

(57) ABSTRACT

A connector is described for terminating a coaxial cable typically comprising a center conductor, an insulating material surrounding the center conductor, and an outer conductor surrounding the insulating material. The coaxial connector includes a center contact having a rear end for soldering to an exposed end portion of the center conductor of a coaxial cable. The rear end has a contact surface with an opening formed therein for receiving the exposed end portion of the center conductor. The contact surface is contactable with the insulating material of the coaxial cable when the exposed end portion of the center conductor is inserted into the opening. Since flow of solder might be impeded by air trapped within the opening, at least one notch is formed in the contact surface to provide a passage between the opening and the exterior of the center contact when the abutting face of the insulating material is in contact with the contact surface. The notch allows the trapped air to escape so that the flow of the solder is not impeded.

### FIELD OF THE INVENTION

The present invention generally relates to connectors for terminating an end of a coaxial cable, and particularly, to a connector with improved electrical connection between the center contact of the connector and the center conductor of the coaxial cable.

### BACKGROUND

Coaxial cables are widely used in the telecommunications industry to transport radio frequency signals. Typically, a coaxial cable comprises a center conductor surrounded by an insulating material forming a dielectric and a round, conductive sheath or outer conductor for shielding the center conductor. Additionally, an insulating protective jacket might cover the outer conductor. Coaxial cables are designed to carry high frequency or broadband signals, usually at radio frequency, with minimal attenuation. The insulating material between the inner and outer conductor forming the dielectric significantly influences the characteristic electrical properties of a coaxial cable, such as impedance and attenuation.

To ensure a minimum attenuation, specially designed connectors such as RF-connectors are used to terminate such coaxial cables. The principal arrangement of such connectors resembles that of coaxial cables to obtain similar transmission properties. Typically, a connector comprises a center contact connected with the center conductor of the coaxial cable and an outer contact connected with the outer conductor of the coaxial cable. The contacts of the connector are insulated from each other by an insulator. To minimise reflection of the carried RF-signals, the connector should exhibit the same impedance as the coaxial cable.

A connector of the type described above is disclosed in the U.S. Pat. No. 6,439,924. Briefly, a center contact is surrounded by an insulator, which in turn is surrounded by an outer contact. The center contact of that connector comprises at its rear end a central bore or opening for receiving an exposed end portion of the center conductor. Typically, the center conductor is soldered in the central bore to ensure optimal electrical connection. Alternatively, the center conductor can be mechanically crimped within the bore. Before soldering, the insulating material, the outer conductor, and the insulating jacket are stripped to expose the end portion of the center conductor. Then, solder applied to the bore is liquefied by heat, and the exposed end portion of the center conductor is inserted into the bore.

Although this connector allows a reliable soldering of the center conductor, it exhibits an insufficient RF performance due to a gap between the abutting face of the insulating material, upon which the exposed portion protrudes, and the rear end of the center contact. Such a gap between the insulating material (dielectric) of the coaxial cable and the center conductor adversely influences the RF performance of the connector. One measure for the RF performance is for instance the voltage standing wave ratio (VSWR) which indicates the impedance mismatch between a transmission line and its load.

To increase the RF-performance, the center conductor can be inserted into the bore of the center contact until the abutting face of the insulating material of the coaxial cable is in intimate contact with the surface of the center conductor. Although this significantly improves the VSWR value, it has been observed that connectors so prepared exhibit poor solder joints.

Detailed investigations of the problems exhibited by the known connectors revealed that bad solder joints might be caused by air trapped inside the bore. During the soldering process, the flow of the liquefied solder can be impeded by air trapped inside the bore when the insulating material of the coaxial cable seals the bore by pressing against the surface of the connector. Due to the impeded flow, the liquefied solder cannot wet the entire surface of the bore and the exposed end portion of the coaxial cable. This results in a poor electrical and mechanical connection.

### SUMMARY

Accordingly, it is an object, among others, of the invention to provide a connector with a reliable solder joint between the center contact and the center conductor of a coaxial cable. It is a further object, among others, of the invention to provide a connector with increased RF performance. Other objects and advantages will be apparent from the following description.

These problems are addressed by a coaxial connector which includes a center contact having a rear end for soldering to an exposed end portion of the center conductor of a coaxial cable. The rear end has a contact surface with an opening formed therein for receiving the exposed end portion of the center conductor. The contact surface is contactable with the insulating material of the coaxial cable when the exposed end portion of the center conductor is inserted into the opening. At least one notch is formed in the contact surface.

### BRIEF DESCRIPTION OF THE DRAWINGS

The invention will now be described by way of example with reference to the accompanying Figures in which:

FIG. 1 is a cross-sectional view of the inventive connector;

FIG. 2 is an enlarged cross-sectional view of the encircled portion of FIG. 1;

FIG. 3 is a part-sectional, part-perspective view of the connector with an additional side hole; and

FIG. 4 is an enlarged part-sectional, part-perspective view of a central portion of FIG. 3 showing the rear end of the center contact.

### DETAILED DESCRIPTION OF THE EMBODIMENT(S)

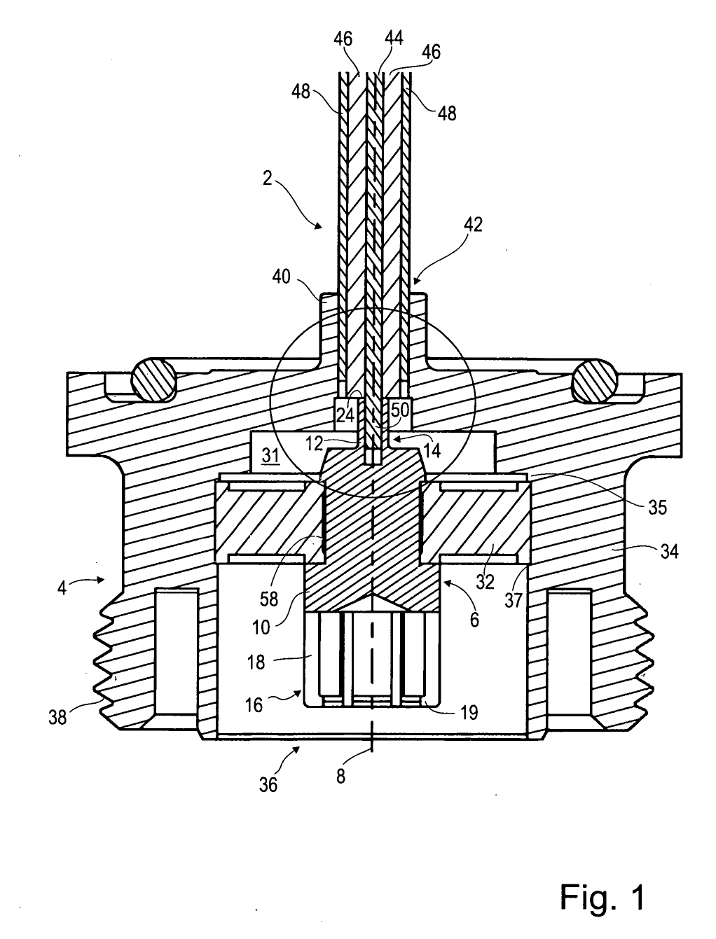

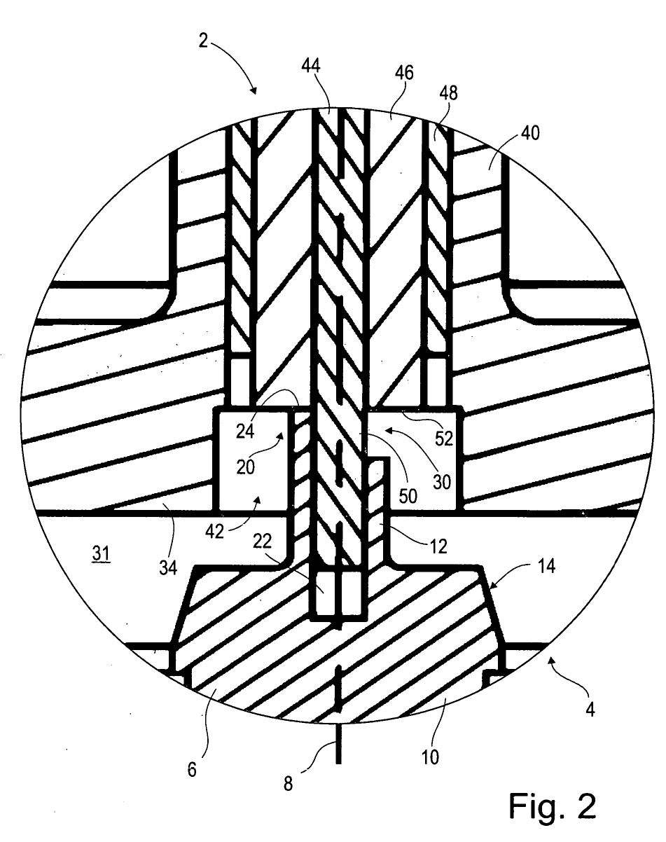

Reference is made to FIGS. 1 and 2, which show a coaxial cable 2 terminated by a connector 4. Throughout the description, the term “rear end” generally refers to that end of the connector or any part of it, which is in connection with or which is directed towards the coaxial cable. On the other hand, the term “front end” generally refers to that end of the connector or any part of it, which will be in connection with or which is directed towards a mating connector.

The connector 4 comprises a center contact 6 with a main body 10 and a receptacle 12 formed on a soldering end 14 of the center contact 6. The main body 10 and the receptacle 12 are integrally formed of a conductive material, particularly of metal. On the front end 16 of center contact 6, spring fingers 18 are formed by a plurality of axially extending tongues which are integrally formed with the main body 10 for receiving a center contact of a mating connector, not shown. The spring fingers 18 have inwardly directed contact points 19 for engaging with the center contact of the mating connector. Spring fingers 18, main body 10 and receptacle 12 are integrally formed as a axially symmetrical body axially aligned with the axis 8 of the connector. In an alternative connector design not shown, the center contact 6 has a front surface for pressing against the center contact of the mating connector to provide the electrical connection.

The receptacle 12 has a cylindrical or ferrule-like shape with an elongate opening 22 axially aligned with the axis of the connector 4. Other shapes are possible as well. The elongate opening 22 extends from a rear end 20 of the receptacle 12 as far as a rear portion of the main body 10 thereby forming a blind bore for receiving an exposed end portion of the center conductor of the coaxial cable 2. Further, on its rear end 20, receptacle 12 has an annular contact surface 24 like the end surface of a hollow cylinder. At least one notch 30 is formed in the contact surface 24 by cutting through the circumferential wall of the receptacle 12 to provide a passage between the elongate opening 22 and the exterior of the receptacle 12. The elongate opening 22 is therefore in communication with a cavity 31 surrounding the center contact 6 so that air trapped in the elongate opening 22 can leak out. In this particular embodiment, the notch 30 has the shape of a rectangular cut through the wall. However, it will be evident to those skilled in the art that the notch can be formed in any shape. Further, the invention is not restricted to only one notch. Two or more notches can be formed in the contact surface to provide respective passages.

Preferably, the size of the notch or the notches should be kept small in order to not adversely affect the RF-performance of the connector. For the purpose of providing a passage to leak out any trapped air, the notch or notches require only a small lateral or circumferential extent. This ensures that a predominant portion of the contact surface 24 is in intimate contact with the insulating material of the coaxial cable to improve the RF performance.

Connector 4 further comprises a disk-like insulator 32 surrounding the center contact 6 and an outer contact 34 surrounding the insulator 32. The insulator 32 has a central opening 58 for receiving and fixing the center contact 6. The outer contact 34 is cup-like and formed with a main opening 36 toward the front end of the connector. Near the rear of the cup, a circumferential shoulder 35 is formed which serves as a stop surface for the insulator 32. An external circumferential surface of the insulator snugly contacts an inner wall of the cup thereby holding and aligning the center contact 6 within the cavity 31 of the outer contact 34. A further shoulder 37 formed opposite the shoulder 35 ensures a firm fit of the insulator 32. A screw thread 38 is formed on the outside of the outer contact 34 for engaging with a respective screw cap of a mating connector, not shown. On its rear end, the outer contact 34 has a hollow shaft 40 with a through hole 42 axially aligned with the axis 8 of the connector. The through hole 42, the diameter of which roughly equals the outer diameter of the coaxial cable with its outer conductor exposed, extends into the inner cavity 31 of the outer contact 34 and provides a rear access to the center contact 6.

Reference is now made to the coaxial cable 2, which comprises a center conductor 44, an insulating material 46 surrounding the center conductor 44, and an outer conductor 48 surrounding the insulating material 46. An optional protective jacket surrounding the outer conductor 48 is not shown. The coaxial cable is prepared at one of its ends for connecting with the connector 4. As shown in FIG. 2, the outer conductor 48 and the insulating material 46 are stripped to expose an end portion 50 of the center conductor 44, which extends beyond an abutting face 52 of the insulating material 46. The outer conductor 48 is stripped even more than the insulating material 46 leaving a portion of the insulating material 46 exposed. To ensure an intimate contact of the insulating material 46 with the contact surface 24 of the receptacle 12 when the coaxial cable is inserted, the exposed end portion 50 of the center conductor is slightly shorter than the axial extension of the elongate opening 22.

Since most of the contact surface 24 is in intimate contact with the insulating material 46 of the coaxial cable 2, the RF performance of the connector remains very good. The small notch 30 does not significantly affect the VSWR value.

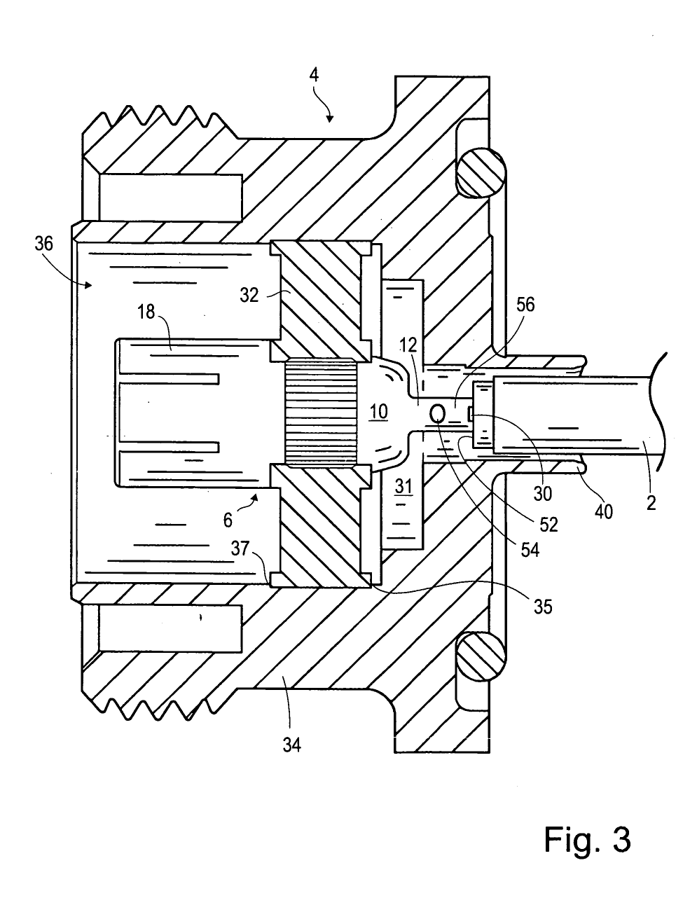

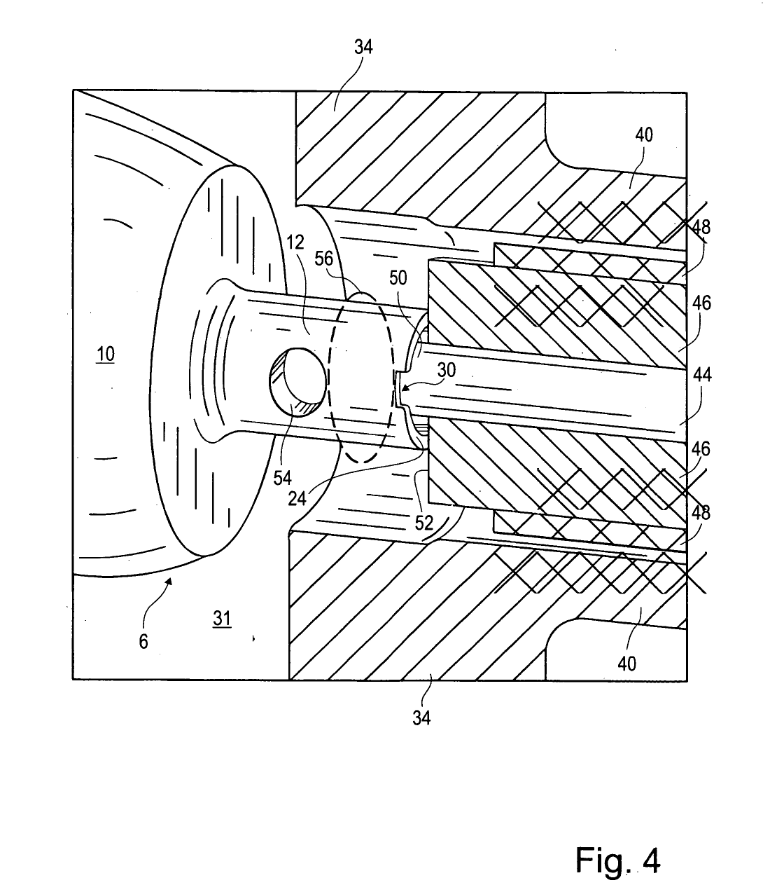

Reference will now be made to FIGS. 3 and 4, which show a modified connector 4 terminating the coaxial cable 2 in a part 3-dimensional view. The same reference signs are used for corresponding features. In this particular embodiment, the receptacle 12 further has a side hole 54 extending perpendicular to the connector axis 8 for improving the plate quality inside the elongate opening 22. Further, by using this hole 54 solder can be added during soldering if required. Additionally, trapped air can escape though the side hole 54 as well. However, the side hole 54 does not entirely ensure that any air trapped can leak out. Particularly, air trapped in a rear portion 56 of the receptacle 12 extending between the side hole 54 and the rear end 20 of the receptacle 12 may be trapped by solder flowing from the bottom towards the aperture of the elongate opening 22. The notch 30 ensures that air even trapped in that rear portion 56 can leak out so that the elongate opening 22 of free of any air.

FIG. 4 giving a part 3-dimensional view of the rear end of the center contact 6 shows the shape of the contact surface 24 which, in this particular embodiment, is annular. The notch 30 has a rectangular shape but could be formed with other shapes as well. Further, the receptacle can include a second notch and/or a plurality of notches of different shapes.

To assemble the connector and to establish an electrical connection between the center conductor 44 and the center contact 6, different assembling sequences or methods can be applied. Three different assembling and soldering sequences will be briefly described below with reference to the Figures.

Sequence A

First, the insulator 32 is pre-assembled with the outer contact 34 by inserting into main opening 36 and press-fitting between shoulders 35 and 37. From the rear side of the connector 4, the coaxial cable 2 is passed through the through hole 42, the central opening 58 of the insulator 32 and the main opening 36 of the outer contact 34. The inner diameter of the through hole 42 is preferably slightly wider than the outer diameter of the coaxial cable 2 to ensure an easy insertion of the coaxial cable 2. In a next step, the center contact 6 is soldered onto the center conductor 44. To this end, the outer conductor 48 and the insulating material 46 of the coaxial cable 2 is stripped to expose the center conductor 44 and to form the abutting face of the insulating material 52. Alternatively, the coaxial cable 2 can be prepared before passing through the through hole 42. The exposed end portion 50 of the center conductor 44 is then inserted into the receptacle 12 until the abutting face 52 is in contact with the contact surface 24. Solder may be applied either by placing a solder wire in the elongate opening 22 before inserting the exposed end portion 50 of the center conductor 44 or by adding through the side hole 54. For the first alternative, a side hole 54 is not required but can be provided to improve the plating quality. The solder joint is finished by applying heat. Air trapped within the elongate opening 22 is pushed out by the liquefied solder through the notch 30. Due to capillary action, the liquefied solder disperses along the inserted end portion 50 of the center conductor 44 and wets both the inner surface of the elongate opening 22 and the surface of the exposed end portion 50 and thereby establishes an electrical connection between the center conductor 44 and the center contact 6. After soldering, the center contact 6 and the soldered coaxial cable are pushed into the central opening 58 of the insulator 32 until the center contact 6 reaches its final assembly position within the connector 4. The center contact 6 may be pressed or slid into the insulator 32. Preferably, the center contact 6 has retaining features to ensure captivation in the insulator 32 such as retaining hooks, snap fittings or similar elements. Finally, a second solder connection is provided between the outer conductor 48 and the outer contact 34 within the through hole 42.

Sequence B

By using this assembling sequence, the center contact 6 is pre-assembled with the insulator 32, which itself is not yet inserted into the outer contact 34. Then, the coaxial cable 2 is passed through the through hole 42 and the main opening 36, prepared to expose its center conductor 44 and soldered onto center contact 6 as described above. After soldering, the assembled center contact 6, coaxial cable 2 and insulator 32 are pushed back into the main opening 36 of the outer contact 34 until the insulator 32 and hence the center contact 6 reach their final positions. Depending on the connector design, the dielectric 32 is pressed or slid into main opening 36. Finally, the second solder joint is made between the outer conductor 48 and the outer contact 34.

Sequence C

Here, the insulator 32 and the center contact 6 are assembled with the outer conductor 34 prior to making the solder joint between the center contact 6 and the center conductor 44. Then, the coaxial cable 2 is prepared and a solder wire is placed into the elongate opening 22 before inserting the center conductor 44 of the coaxial cable into the elongate opening 22. Alternatively, solder may be applied prior to assembly of the center contact 6. By applying heat, the solder joint is finished. Preferably, the center contact 6 is inductively heated by using specific equipment, which has access to the center contact 6 via the main opening 36. A side hole 54 is not required when using this assembling sequence but can be provided for improving the plate quality. Again, the solder joint between the outer conductor 48 and the outer contact is made.

Advantageously, due to the notch 30 on the contact surface 24 between the elongate opening 22 and exterior of the center contact 6, trapped air can escape even when the insulating material 46 of the coaxial cable 2 is pressed, preferably with its abutting face 52, against the contact surface 24. This guarantees an unimpeded flow of the liquefied solder and ensures a reliable electrical and mechanical connection between the center contact 6 and the cable center conductor 44. Since the notch 30 is formed on the entrance of the opening 22, no enclosed or sealed cavity remains within the opening 22 in which air might be trapped. The notch 30 should be sufficient in size to prevent sealing by the resilient insulating material when it is pressed against the contact surface.

Additionally, since the insulating material 46 of the coaxial cable 2 remains in intimate contact with the contact surface 24 of the center contact 6, the RF performance of the connector 4 is improved. To limit any unwanted effect on the RF performance, the size of the notch 30 should be kept small. Particularly, most of the contact surface 24 of the opening 22 shall remain in contact with the insulating material 46. In other words, the portion of the contact surface 24 covered by the notch 30 should be comparatively small.

The size, number and shape of the notch 30 or notches can vary to meet different requirements. Again, even when the contact surface 24 comprises two or more notches 30, the overall portion covered by the notches 30 should preferably be kept small to avoid any adverse effects on the RF performance.

Contrary to connectors which leave a gap between the center contact and the insulating material of the coaxial cable as for instance disclosed in the aforementioned U.S. Pat. No. 6,439,924, the notch 30 of the present invention provides a well defined opening for leaking trapped air while ensuring the contact between the center contact 6 and the insulating material 46. As a consequence of the notch 30, the assembling of the connector 4 and the coaxial cable 2 is facilitated since no complicated longitudinal alignment of the coaxial cable 2 is required to provide a gap.

The notch 30 allows any trapped air to escape during soldering so that the whole surface of the inserted end portion and an inner surface of the bore are fully wetted by the solder to form a reliable electrical connection.

All aspects and advantages outlined above with respect to the connector apply to the connector terminating the coaxial cable as well and are not repeated here to avoid superfluous repetitions.

Although the present invention is described using a connector having an elongate configuration, the present invention is not restricted to this particular configuration, but can be embodied in any other configuration such as e.g. a L-shaped or right angle configuration.

1. A connector for a coaxial cable comprising:
a center contact having a rear end for soldering to an exposed end portion of a center conductor of the coaxial cable;
an opening extending from the rear end for receiving the exposed end portion of the center conductor;
a contact surface located on the rear end around the opening, the contact surface being contactable with insulating material of the coaxial cable when the exposed end portion of the center conductor is inserted into the opening, and;
at least one notch formed in the contact surface.

2. The connector as claimed in claim 1, wherein the center contact comprises a main body and a receptacle having a bore which forms the opening for receiving the exposed end portion.

3. The connector as claimed in claim 2, wherein the opening is axially aligned with the receptacle.

4. The connector as claimed in claim 3, wherein the receptacle further comprises a side hole.

5. The connector as claimed in claim 4, wherein the side hole extends perpendicular to the axis of the opening.

6. The connector as claimed in claim 1, further comprising an outer contact surrounding the center contact, the outer contact and the center contact being axially aligned, and an insulator that is arranged between the center contact and the outer contact.

7. The connector as claimed in claim 6, wherein the outer contact encloses the rear end of the center contact and comprises a through hole axially aligned with the opening of the center contact to provide access to the opening, the size of the through hole being sufficiently wide to accommodate the coaxial cable with the exposed outer conductor when inserted into the through hole.
